(19) United States
(12) Patent Application Publication
(10) Pub. No.: US 2019/0012528 A1
(43) Pub. Date: Jan. 10, 2019

(54) FACIAL EXPRESSION RECOGNITION SYSTEM, FACIAL EXPRESSION RECOGNITION METHOD, AND FACIAL EXPRESSION RECOGNITION PROGRAM

(71) Applicant: FOVE, INC., Tokyo (JP)

(72) Inventors: Lochlainn Wilson, Tokyo (JP); Keiichi Seko, Tokyo (JP); Yuka Kojima, Tokyo (JP); Yamato Kaneko, Tokyo (JP)

(73) Assignee: FOVE, INC., San Mateo, CA (US)

(21) Appl. No.: 16/069,984

(22) PCT Filed: Jan. 13, 2016
(86) PCT No.: PCT/JP2016/050869

§ 371 Date: Jul. 13, 2018

(51) Int. Cl. G06K 9/00; G06F 3/01; H04N 5/33; H04N 13/25; H04N 13/254; H04N 13/383; G06T 7/73

(52) U.S. Cl. CPC G06K 9/00308; G06F 3/013; G06F 3/012; H04N 5/332; H04N 13/25; H04N 13/254; G06K 9/00281; G06T 7/73; G06T 2207/10152; G06T 2207/20212; G06T 2207/10012; G06T 2207/30201; G06T 2207/10048; H04N 13/383

(57) ABSTRACT

A facial expression recognition system including a head mounted display including a first camera that images eyes of a user, a second camera that images a mouth of the user, and an output unit that outputs a first image captured by the first camera and a second image captured by the second camera; and a facial expression recognition device including a reception unit that receives the first image and the second image output by the output unit, and an expression recognition unit that recognizes a facial expression of the user on the basis of the first image and the second image.

### TECHNICAL FIELD

The present invention relates to a head mounted display.

### BACKGROUND ART

A technology of detecting a gaze direction of a user by irradiating eyes of the user with invisible light such as near-infrared light and analyzing an image of the eyes of the user including reflected light thereof is known. In reality, information on the detected gaze direction of the user is reflected in a monitor such as a personal computer (PC) or a game machine, which is used as a pointing device.

### CITATION LIST

### Patent Literature

[Patent Literature 1]
Japanese Unexamined Patent Application, First Publication No. Hei 2-264632

### Non-Patent Literature

[Non-Patent Literature 1]
URL: http://www.hao-li.com/publications/papers/siggraph 2015FPSHMD.pdf (As of Nov. 24, 2015)

### SUMMARY OF INVENTION

### Technical Problem

Some head mounted displays have a function of presenting a three-dimensional image to a user who wears the head mounted display. In general, the head mounted display is used while the head mounted display is worn and covers a view of the user. As described above, it is desirable to provide content that further attracts interest of the user, in content in which the gaze direction of the user is used as a pointing device.

The present invention has been made in view of the above-described demands, and an object of the present invention is to provide a head mounted display capable of outputting information for providing content that can further attract an interest of a user.

### Solution to Problem

In order to solve the above problem, an aspect of the present invention is a facial expression recognition system including: a head mounted display including a first camera that images eyes of a user, a second camera that images a mouth of the user, and an output unit that outputs a first image captured by the first camera and a second image captured by the second camera; and a facial expression recognition device including a reception unit that receives the first image and the second image output by the output unit, and an expression recognition unit that recognizes a facial expression of the user on the basis of the first image and the second image.

Further, the head mounted display further may include a light source that irradiates the eyes of the user with invisible light; and a third camera that images the invisible light reflected by the eyes of the user, the output unit may output a third image captured by the third camera, and the facial expression recognition device may further include a gaze detection unit that detects a gaze direction of the user on the basis of the third image received by the reception unit.

The facial expression recognition device may further include a combination unit that combines the first image and the second image received by the reception unit to create a combined image, and the facial expression recognition unit may recognize the facial expression of the user on the basis of the combined image.

Further, the second camera may be detachably attached to the head mounted display.

Further, the second camera may be attached to the head mounted display so that a range from a nose to a shoulder of the user becomes an imageable angle of view when the user wears the head mounted display.

Further, the facial expression recognition system may further include a posture estimation unit that estimates a posture of the user on the basis of the second image received by the reception unit.

Further, the head mounted display may be configured to cover the periphery of the eyes of the user and not to cover the mouth of the user.

The first camera and the second camera may be cameras that acquire depth information indicating a distance to an imaging target, and the facial expression recognition system may further include an avatar image generation unit that specifies a three-dimensional shape of the eyes and the mouth of the user on the basis of the image of the eyes of the user captured by the first camera and the image of the mouth of the user captured by the second camera, and generates an avatar image in which the specified three-dimensional shape is reflected in the shape of the eyes and the mouth of the avatar of the user on the basis of the specified three-dimensional shape.

It should be noted that conversion of any combination of the above components and representations of the present invention among a method, a device, a system, a computer program, a data structure, a recording medium, and the like is also effective as an aspect of the present invention.

### Advantageous Effects of Invention

According to the present invention, even in a head mounted display in which it is difficult to acquire a facial image of the entire face of the user, it is possible to acquire a combined image reminiscent of the facial image of the user and perform a facial expression recognition process by separately imaging the eyes and the mouth of the user and combining the images. Therefore, it is possible to provide content in which the facial expression of the user is reflected.

### BRIEF DESCRIPTION OF DRAWINGS

FIG. 1 is an external view illustrating a state in which a user wears a head mounted display according to an embodiment;

FIG. 2 is a perspective view schematically illustrating an overview of an image display system of the head mounted display according to the embodiment;

FIG. 3 is a diagram schematically illustrating an optical configuration of an image display system of the head mounted display according to the embodiment;

FIG. 4 is a block diagram illustrating a configuration of the head mounted display system according to the embodiment.

FIG. 5 is a schematic diagram illustrating calibration for detection of a gaze direction according to the embodiment;

FIG. 6 is a schematic diagram illustrating position coordinates of a cornea of a user;

FIG. 7(a) illustrates an example of an image of the periphery of the eyes of a user captured by the head mounted display system according to the embodiment. FIG. 7(b) illustrates an example of an image of the periphery of the mouth of the user captured by the head mounted display system according to the embodiment.

FIG. 8 is an example of a combined image showing a user captured by the head mounted display according to the embodiment.

FIG. 9 is a flowchart illustrating an operation of the head mounted display system according to the embodiment.

FIG. 10 illustrates an example of a combined image showing a user captured by the head mounted display according to the embodiment.

FIGS. 11(a) and 11(b) are external views illustrating a structure in a case in which a camera is detachably attached to the head mounted display.

FIG. 12 is an external view illustrating an example in which a camera angle of a camera 160 provided in the head mounted display is changed.

FIG. 13(a) illustrates an image obtained by imaging a user, and FIG. 13(b) is an image in which a facial expression of the imaged user is reflected in an avatar image.

### DESCRIPTION OF EMBODIMENTS

### <Knowledge Obtained by Inventors>

In the head mounted display as described above, when the facial expression of the user can be recognized, more realistic and active content can be provided. For example, a usage method of changing a facial expression of a character controlled by the user according to the facial expression of the user or changing a correspondence of the character displayed on the head mounted display is conceivable.

However, in many cases, current head mounted displays have shapes that normally cover the periphery of the eyes in the head of a user. Head mounted displays have such shapes because there is a problem in that a full helmet type gives a feeling of pressure to the user, and a weight of the head mounted display increases and causes a load on the user. However, due to such a structure, while an image of the periphery of the eyes of a user can be captured with a camera inside the head mounted display, an entire facial image of the user cannot be acquired.

A scheme for realizing facial expression recognition in a head mounted display having such a shape includes a technology described in Non-Patent Literature 1. According to this literature, a curved type arm is attached to the outside of a head mounted display, and a camera is placed on the side opposite to the side to which the curved type arm is attached to image the mouth of a user, thereby realizing facial expression recognition. However, in the case of the shape shown in Non-Patent Literature 1, the inventors have found that there is a problem in that a centroid of the head mounted display is biased toward the front of the user as a whole due to the attached curved type arm, making handling difficult, and a total weight of the head mounted display increases.

Further, the inventors have recognized that, in the technology described in Non-Patent Literature 1, facial expression recognition of the periphery of the eyes is realized by detecting a motion of the facial muscles around the eyes of a user using a strain sensor, but a scheme using a strain sensor is not suitable for detection of a gaze of a user.

Therefore, the inventors have invented a configuration capable of executing gaze detection while executing facial expression recognition in a current type of head mounted display that covers a current view of a user. Hereinafter, the head mounted display according to the present invention will be described in detail.

### Embodiment

A facial expression recognition system 1 according to an aspect of the present invention includes a head mounted display (100) including a first camera (181) that images the eyes of a user, a second camera (180) that images the mouth of the user, and an output unit (118) that outputs a first image captured by the first camera and a second image captured by the second camera, and a facial expression recognition device (200) including a reception unit (220) that receives the first image and the second image output by the output unit, a combination unit (222) that combines the first image and the second image received by the reception unit to create a combined image, and a facial expression recognition unit (223) that recognizes a facial expression of the user on the basis of the combined image created by the combination unit.

Further, the head mounted display further includes a light source (103) that irradiates the eyes of the user with invisible light, and a third camera (161) that images the invisible light reflected by the eyes of the user, the output unit outputs a third image captured by the third camera, and the facial expression recognition device further includes a gaze detection unit (221) that detects a gaze direction of the user on the basis of the third image received by the reception unit. This will be described in detail below.

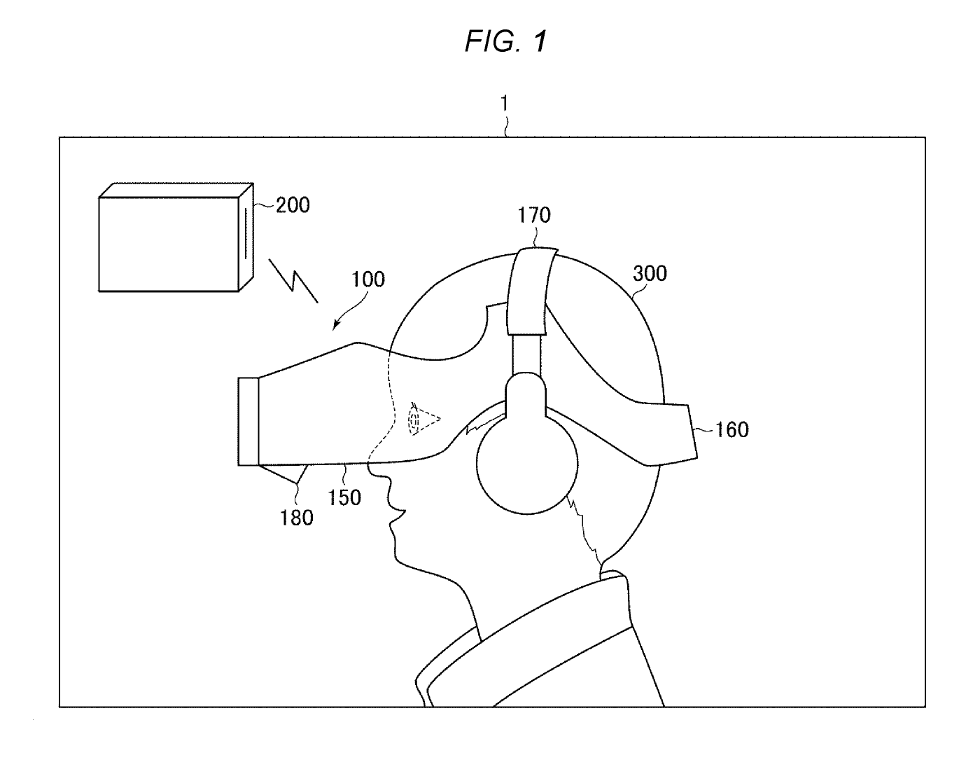

FIG. 1 is a diagram schematically illustrating an overview of a facial expression recognition system 1 according to an embodiment. The facial expression recognition system 1 according to the embodiment includes a head mounted display 100 and a gaze detection device 200. As illustrated in FIG. 1, the head mounted display 100 is mounted on the head of the user 300 for use.

The gaze detection device 200 detects a gaze direction of at least one of right and left eyes of the user wearing the head mounted display 100, and specifies a focus of the user, that is, a gaze point of the user in a three-dimensional image displayed on the head mounted display. Further, the gaze detection device 200 also functions as a video generation device that generates videos displayed by the head mounted display 100. For example, the gaze detection device 200 is a device capable of reproducing videos of stationary game machines, portable game machines, PCs, tablets, smartphones, phablets, video players, TVs, or the like, but the present invention is not limited thereto. The gaze detection device 200 is wirelessly or wiredly connected to the head mounted display 100. In the example illustrated in FIG. 1, the gaze detection device 200 is wirelessly connected to the head mounted display 100. The wireless connection between the gaze detection device 200 and the head mounted display 100 can be realized using a known wireless communication technology such as Wi-Fi (registered trademark) or Bluetooth (registered trademark). For example, transfer of videos between the head mounted display 100 and the gaze detection device 200 is executed according to a standard such as Miracast (registered trademark), WiGig (registered trademark), or WHDI (registered trademark).

FIG. 1 illustrates an example in which the head mounted display 100 and the gaze detection device 200 are different devices. However, the gaze detection device 200 may be built into the head mounted display 100.

The head mounted display 100 includes a housing 150, a fitting harness 160, headphones 170, and a camera 180. The housing 150 houses an image display system, such as an image display element, for presenting videos to the user 300, and a wireless transfer module (not illustrated) such as a Wi-Fi module or a Bluetooth (registered trademark) module. The fitting harness 160 is used to mount the head mounted display 100 on the head of the user 300. The fitting harness 160 may be realized by, for example, a belt or an elastic band. When the user 300 wears the head mounted display 100 using the fitting harness 160, the housing 150 is arranged at a position where the eyes of the user 300 are covered. Thus, if the user 300 wears the head mounted display 100, a field of view of the user 300 is covered by the housing 150.

The headphones 170 output audio for the video that is reproduced by the gaze detection device 200. The headphones 170 may not be fixed to the head mounted display 100. Even when the user 300 wears the head mounted display 100 using the fitting harness 160, the user 300 may freely attach or detach the headphones 170.

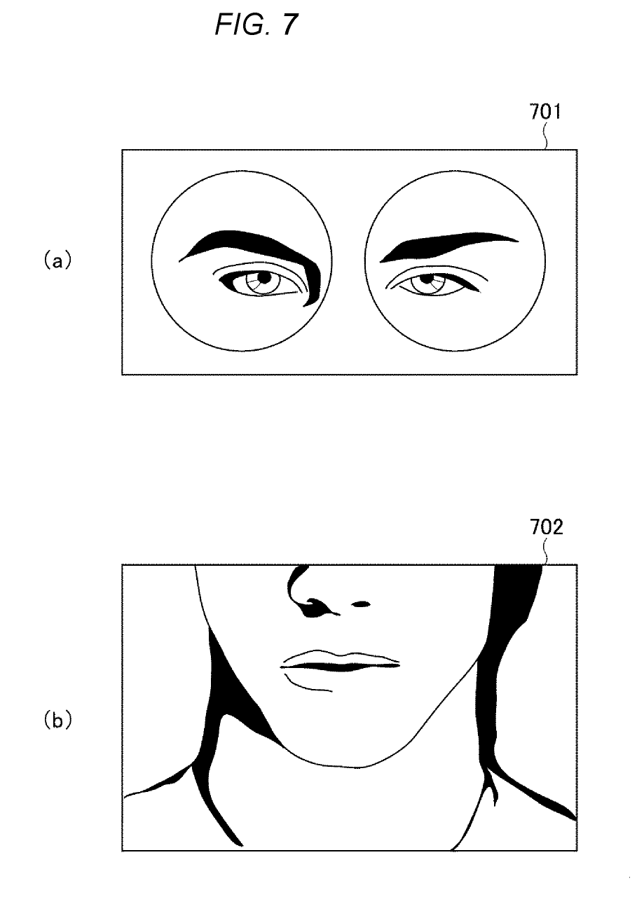

As illustrated in FIG. 1, the camera 180 is disposed such that the camera 180 can capture an image including half of the face of the user when the user 300 wears the head mounted display 100. That is, the camera 180 is disposed such that an imaging angle of view becomes an angle of view at which the camera 180 can image a lower half (from a lower side of a nose of the user to a shoulder of the user) of the face of the user 300. That is, the camera 180 captures a first image 801 as illustrated in FIG. 7(b). In this specification, the image (an image including the lower half of the face of the user) is referred to as a first image. In FIG. 1, although not illustrated, the camera 180 is connected to a first communication unit 118 to be described below. The first image captured by the camera 180 is output to the gaze detection device 200 by the first communication unit 118. As the camera 180, a visible light camera or a depth camera is used. When the depth camera is used as the camera 180, a distance from the camera 180 to an imaging target can be specified, and therefore, a three-dimensional shape of a lower half of the face of the user can be specified. It should be noted that the depth camera refers to a camera that can acquire depth information from the camera to a subject or a camera that can acquire a three-dimensional shape of a subject. Specific examples of the depth camera may include a stereo camera, a light field camera, a camera using a structure light, and a camera using an illumination difference stereo method.

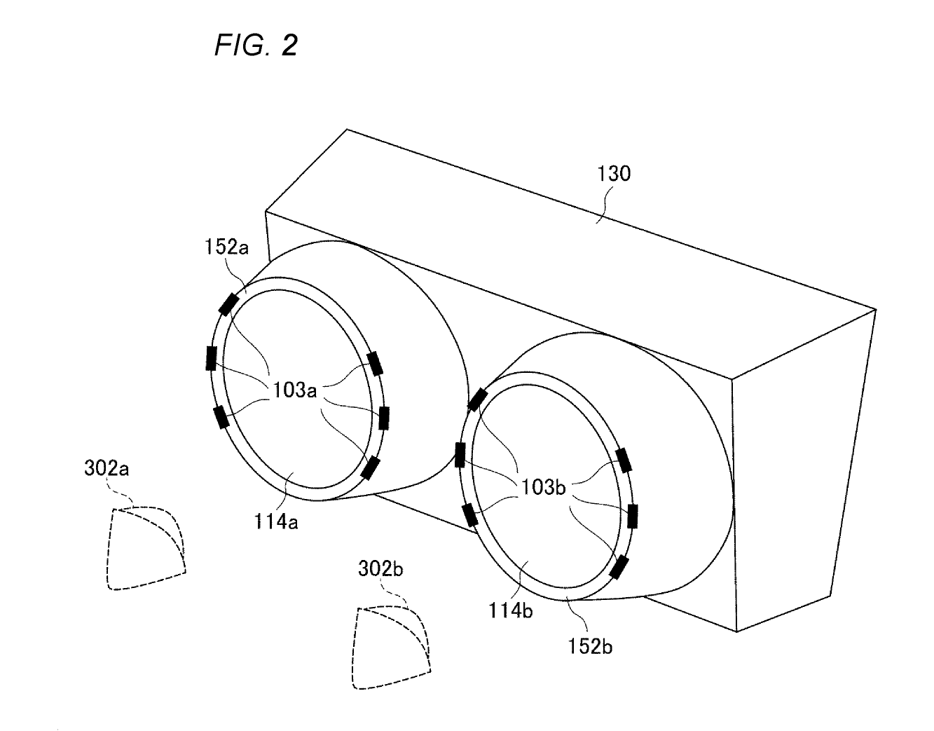

FIG. 2 is a perspective diagram illustrating an overview of the image display system 130 of the head mounted display 100 according to the embodiment. Specifically, FIG. 2 illustrates a region of the housing 150 according to an embodiment that faces corneas 302 of the user 300 when the user 300 wears the head mounted display 100.

As illustrated in FIG. 2, a convex lens 114a for the left eye is arranged at a position facing the cornea 302a of the left eye of the user 300 when the user 300 wears the head mounted display 100. Similarly, a convex lens 114b for a right eye is arranged at a position facing the cornea 302b of the right eye of the user 300 when the user 300 wears the head mounted display 100. The convex lens 114a for the left eye and the convex lens 114b for the right eye are gripped by a lens holder 152a for the left eye and a lens holder 152b for the right eye, respectively.

Hereinafter, in this specification, the convex lens 114a for the left eye and the convex lens 114b for the right eye are simply referred to as a “convex lens 114” unless the two lenses are particularly distinguished. Similarly, the cornea 302a of the left eye of the user 300 and the cornea 302b of the right eye of the user 300 are simply referred to as a “cornea 302” unless the corneas are particularly distinguished. The lens holder 152a for the left eye and the lens holder 152b for the right eye are referred to as a “lens holder 152” unless the holders are particularly distinguished.

A plurality of infrared light sources 103 are included in the lens holders 152. For the purpose of brevity, in FIG. 2, the infrared light sources that irradiate the cornea 302a of the left eye of the user 300 with infrared light are collectively referred to as infrared light sources 103a, and the infrared light sources that irradiate the cornea 302b of the right eye of the user 300 with infrared light are collectively referred to as infrared light sources 103b. Further, the infrared light sources 103a and the infrared light sources 103b are referred to as “infrared light sources 103” unless the infrared light sources 103a and the infrared light sources 103b are particularly distinguished. In the example illustrated in FIG. 2, six infrared light sources 103a are included in the lens holder 152a for the left eye. Similarly, six infrared light sources 103b are included in the lens holder 152b for the right eye. Thus, the infrared light sources 103 are not directly arranged in the convex lenses 114, but are arranged in the lens holders 152 that grip the convex lenses 114, making the attachment of the infrared light sources 103 easier.

This is because machining for attaching the infrared light sources 103 is easier than for the convex lenses 114 that are made of glass or the like since the lens holders 152 are typically made of a resin or the like.

As described above, the lens holders 152 are members that grip the convex lenses 114. Therefore, the infrared light sources 103 included in the lens holders 152 are arranged around the convex lenses 114. Although there are six infrared light sources 103 that irradiate each eye with infrared light herein, the number of the infrared light sources 103 is not limited thereto. There may be at least one light source 103 for each eye, and two or more light sources 103 are desirable.

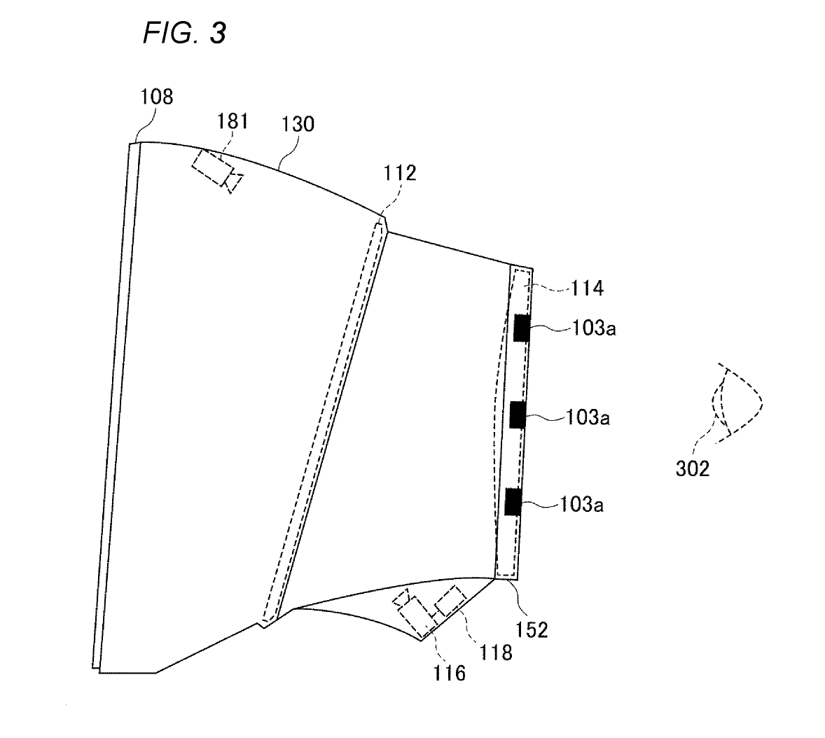

FIG. 3 is a schematic diagram of an optical configuration of the image display system 130 contained in the housing 150 according to the embodiment, and is a diagram illustrating a case in which the housing 150 illustrated in FIG. 2 is viewed from a side surface on the left eye side. The image display system 130 includes infrared light sources 103, an image display element 108, a hot mirror 112, the convex lenses 114, a camera 116, a first communication unit 118, and a camera 181.

The infrared light sources 103 are light sources capable of emitting light in a near-infrared wavelength region (700 nm to 2500 nm range). Near-infrared light is generally light in a wavelength region of non-visible light that cannot be observed by the naked eye of the user 300.

The image display element 108 displays an image to be presented to the user 300. The image to be displayed by the image display element 108 is generated by a video output unit 224 in the gaze detection device 200. The video output unit 224 will be described below. The image display element 108 can be realized by using an existing liquid crystal display (LCD) or organic electro luminescence display (organic EL display).

The hot mirror 112 is arranged between the image display element 108 and the cornea 302 of the user 300 when the user 300 wears the head mounted display 100. The hot mirror 112 has a property of transmitting visible light created by the image display element 108 but reflecting near-infrared light.

The convex lenses 114 are arranged on the opposite side of the image display element 108 with respect to the hot mirror 112. In other words, the convex lenses 114 are arranged between the hot mirror 112 and the cornea 302 of the user 300 when the user 300 wears the head mounted display 100. That is, the convex lenses 114 are arranged at positions facing the corneas 302 of the user 300 when the user 300 wears the head mounted display 100.

The convex lenses 114 condense image display light that is transmitted through the hot mirror 112. Thus, the convex lenses 114 function as image magnifiers that enlarge an image created by the image display element 108 and present the image to the user 300. Although only one of each convex lens 114 is illustrated in FIG. 2 for convenience of description, the convex lenses 114 may be lens groups configured by combining various lenses or may be a plano-convex lens in which one surface has curvature and the other surface is flat.

A plurality of infrared light sources 103 are arranged around the convex lens 114. The infrared light sources 103 emit infrared light toward the cornea 302 of the user 300.

Although not illustrated in the figure, the image display system 130 of the head mounted display 100 according to the embodiment includes two image display elements 108, and can independently generate an image to be presented to the right eye of the user 300 and an image to be presented to the left eye of the user. Accordingly, the head mounted display 100 according to the embodiment may present a parallax image for the right eye and a parallax image for the left eye to the right and left eyes of the user 300. Thereby, the head mounted display 100 according to the embodiment can present a stereoscopic video that has a feeling of depth for the user 300.

As described above, the hot mirror 112 transmits visible light but reflects near-infrared light. Thus, the image light emitted by the image display element 108 is transmitted through the hot mirror 112, and reaches the cornea 302 of the user 300. The infrared light emitted from the infrared light sources 103 and reflected in a reflective area inside the convex lens 114 reaches the cornea 302 of the user 300.

The infrared light reaching the cornea 302 of the user 300 is reflected by the cornea 302 of the user 300 and is directed to the convex lens 114 again. This infrared light is transmitted through the convex lens 114 and is reflected by the hot mirror 112. The camera 116 includes a filter that blocks visible light and images the near-infrared light reflected by the hot mirror 112. That is, the camera 116 is a near-infrared camera which images the near-infrared light emitted from the infrared light sources 103 and reflected by the cornea of the eye of the user 300.

Although not illustrated in the figure, the image display system 130 of the head mounted display 100 according to the embodiment includes two cameras 116, that is, a first imaging unit that captures an image including the infrared light reflected by the right eye and a second imaging unit that captures an image including the infrared light reflected by the left eye. Thereby, images for detecting gaze directions of both the right eye and the left eye of the user 300 can be acquired. It should be noted that when information on focus coordinates in a depth direction is not required for the gaze of the user, it is sufficient to detect the gaze of either the right eye or the left eye.

The first communication unit 118 outputs the image captured by the camera 116 to the gaze detection device 200 that detects the gaze direction of the user 300. Specifically, the first communication unit 118 transmits the image captured by the camera 116 to the gaze detection device 200. Although the gaze detection unit 221 functioning as a gaze direction detection unit will be described below in detail, the gaze direction unit is realized by a gaze detection program executed by a central processing unit (CPU) of the gaze detection device 200. When the head mounted display 100 includes computational resources such as a CPU or a memory, the CPU of the head mounted display 100 may execute the program that realizes the gaze direction detection unit.

As will be described below in detail, bright spots caused by near-infrared light reflected by the cornea 302 of the user 300 and an image of the eyes including the cornea 302 of the user 300 observed in a near-infrared wavelength region are captured in the image captured by the camera 116.

Although the configuration for presenting the image to the left eye of the user 300 in the image display system 130 according to the embodiment has mainly been described above, a configuration for presenting an image to the right eye of the user 300 is the same as above.

An optical configuration for realizing the gaze detection in the head mounted display has been described above. In the head mounted display according to this embodiment, an optical configuration for realizing the facial expression recognition for recognizing a facial expression of the user is further included. Specifically, as illustrated in FIG. 3, the head mounted display 100 includes a camera 181 for imaging the periphery of the eyes of the user.

The camera 181 is a camera that images the periphery of the eyes of the user, and a visible light camera or a depth camera is used. When the depth camera is used as the camera 181, a distance from the camera 181 to an imaging target can be specified, and therefore, a three-dimensional shape of a lower half of the face of the user can be specified. As illustrated in FIG. 3, the camera 181 is disposed at a position at which the eyes of the user facing the convex lens 114 are imaged over the convex lens 114 within the head mounted display, which is a position at which the view of the user gazing at the image display element 108 is not interfered. In FIG. 3, the camera 181 is disposed at the upper portion of the image display system 130. However, the camera 181 may be disposed at the bottom or the left and right, which is not the upper portion, as long as this is at a position at which the view of the user is not interfered and a position at which the periphery of the eyes of the user can be imaged. In FIG. 3, although not illustrated in order to make the drawing easy to see, the camera 181 is connected to the first communication unit 118, and the camera 181 transfers the captured image to the first communication unit 118. The first communication unit 118 outputs the image captured by the camera 181 to the gaze detection device 200. Hereinafter, in the present specification, an image of the periphery of the eyes of the user captured by the camera 181 is referred to as a second image.

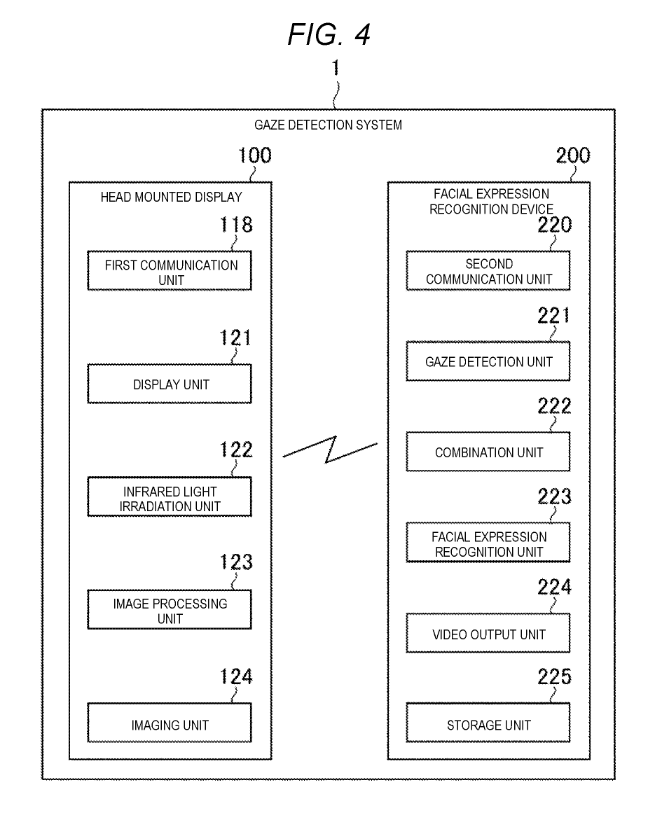

FIG. 4 is a block diagram of the head mounted display 100 and the gaze detection device 200 according to the facial expression recognition system 1. As illustrated in FIG. 4, and as described above, the facial expression recognition system 1 includes the head mounted display 100 and the gaze detection device 200 which communicate with each other.

As illustrated in FIG. 4, the head mounted display 100 includes the first communication unit 118, a display unit 121, the infrared light irradiation unit 122, the image processing unit 123, and the imaging unit 124.

The first communication unit 118 is a communication interface having a function of communicating with the second communication unit 220 of the gaze detection device 200. As described above, the first communication unit 118 communicates with the second communication unit 220 through wired or wireless communication. Examples of usable communication standards are as described above. The first communication unit 118 transmits image data to be used for gaze detection transferred from the camera 116 or the image processing unit 123 to the second communication unit 220. Further, the first communication unit 118 transfers three-dimensional image data transmitted from the gaze detection device 200 to the display unit 121. The first communication unit 118 performs ID attachment so that the image for gaze detection captured by the camera 116 and the first image and the second image are distinguishable from each other, and transfers the resultant images to the facial expression recognition device 200.

The display unit 121 has a function of displaying the three-dimensional image transferred from the first communication unit 118 on the image display element 108. The three-dimensional image data includes a parallax image for the right eye and a parallax image for the left eye, which form a parallax image pair.

The infrared light irradiation unit 122 controls the infrared light sources 103 and irradiates the right eye or the left eye of the user with infrared light.

The image processing unit 123 performs image processing on the image captured by the camera 116 as necessary, and transfers a processed image to the first communication unit 118.

The imaging unit 124 captures an image of near-infrared light reflected by each eye using the right-eye camera 116 and the left-eye camera 117. The imaging unit 124 transfers the image obtained by the imaging to the first communication unit 118 or the image processing unit 123. In addition, the imaging unit 124 transfers the image captured using the camera 180 and the image captured using the camera 181 to the first communication unit 118 or the image processing unit 123.

As illustrated in FIG. 4, the gaze detection device 200 includes the second communication unit 220, the gaze detection unit 221, the combination unit 222, a facial expression recognition unit 223, a video output unit 224, and a storage unit 225.

The second communication unit 220 is a communication interface having a function of communicating with the first communication unit 118 of the head mounted display 100. As described above, the second communication unit 220 communicates with the first communication unit 118 through wired communication or wireless communication. When the second communication unit 220 receives the data related to the left eye image or the right eye image for gaze detection, the second communication unit 220 transfers the data to the gaze detection unit 221. In addition, when the second communication unit 220 receives data related to the facial image of the user (an image around the eyes of the user or an image of a lower half of the face of the user), that is, data related to the first image or the second image, the second communication unit 220 transfers the data to the combination unit 222.

The gaze detection unit 221 receives the image data for gaze detection of the right eye of the user from the second communication unit 220, and detects the gaze direction of the right eye of the user. Using a scheme to be described below, the gaze detection unit 221 calculates a right eye gaze vector indicating a gaze direction of the right eye of the user.

Similarly, the gaze detection unit 221 receives the image data for gaze detection of the left eye of the user from the second communication unit 220 and detects the gaze direction of the left eye of the user. The gaze detection unit 221 calculates a left-eye gaze vector indicating the gaze direction of the left eye of the user using a scheme to be described below.

The gaze detection unit 221 specifies focus coordinates gazed by the user including information in the depth direction on the basis of the right-eye gaze vector and the left-eye gaze vector of user. It should be noted that when only the image of one of the right eye and left eye is used, the gaze detection unit 221 specifies focus coordinates gazed by the user including no information in the depth direction.

The combination unit 222 creates a combined image using the first image and the second image transferred from the second communication unit 220. The combination unit 222 holds information on a positional relationship for combining the first image and the second image in advance and combines the first image and the second image to match the positional relationship. It should be noted that the positional relationship is determined according to a camera angle of each of the cameras 180 and 181, an imaging range, a distance to the user, and the like. The combination unit 222 can obtain a simple facial image of a user by combining the first image and the second image. The combination unit 222 transfers the facial image of the user obtained by combination to the facial expression recognition unit 223.

The facial expression recognition unit 223 executes the facial expression recognition process on the basis of the combined image showing the face of the user transferred from the combination unit 222. The facial expression recognition process is a process of extracting feature points of the facial image for specifying a type of facial expression of the user, and may include a process of specifying an emotion inferred from the facial expression of the user. An example of a scheme of facial expression recognition using the facial image includes a method of extracting feature points from a facial image and estimating facial expression using pattern matching, which may be used. The facial expression recognition unit 223 transfers the estimated facial expression of the user 300 to the video output unit 224.

The video output unit 224 generates the three-dimensional video data to be displayed by the first display unit 121 of the head mounted display 100 and transfers the three-dimensional video data to the second communication 220. Also, the video output unit 224 generates marker image data to be used for calibration for gaze detection and transfers the marker image data to the second communication unit 220. The video output unit 224 holds the coordinate system of the three-dimensional image to be output, and information indicating the three-dimensional position coordinates of the object to be displayed in the coordinate system.

Further, the video output unit 224 also has a function of outputting a moving image, a game image, and the like to be displayed on the display unit 121 of the head mounted display 100. For example, in the case in which the video output unit 224 has a function of outputting an image (avatar image) of a character operated by the user 300, the video output unit 224 generates and outputs an image of a facial expression matched with the facial expression estimated by the facial expression recognition unit 223. Further, alternatively, for example, when the user 300 is communicating with the character output by the video output unit 224 and displayed on the head mounted display 100, the video output unit 224 may generate and outputs a character image showing a reaction according to the estimated facial expression of the user 300.

The storage unit 225 is a recording medium that stores various programs or data required for the operation of the gaze detection device 200.

Next, the gaze direction detection according to the embodiment will be described.

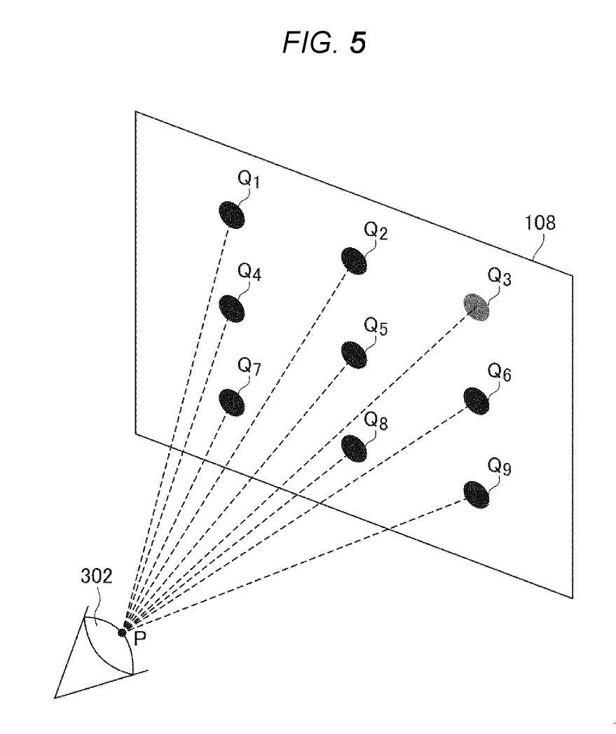

FIG. 5 is a schematic diagram illustrating calibration for detection of the gaze direction according to the embodiment. The gaze direction of the user 300 is realized by the gaze detection unit 221 in the gaze detection device 200 analyzing the video captured by the camera 116 and output to the gaze detection device 200 by the first communication unit 118.

The video output unit 224 generates nine points (marker images) including points Q₁ to Q₉ as illustrated in FIG. 5, and causes the points to be displayed by the image display element 108 of the head mounted display 100. The gaze detection device 200 causes the user 300 to sequentially gaze at the points Q₁ up to Q₉. In this case, the user 300 is requested to gaze at each of the points by moving his or her eyeballs as much as possible without moving his or her neck. The camera 116 captures images including the cornea 302 of the user 300 when the user 300 is gazing at the nine points including the points Q₁ to Q₉.

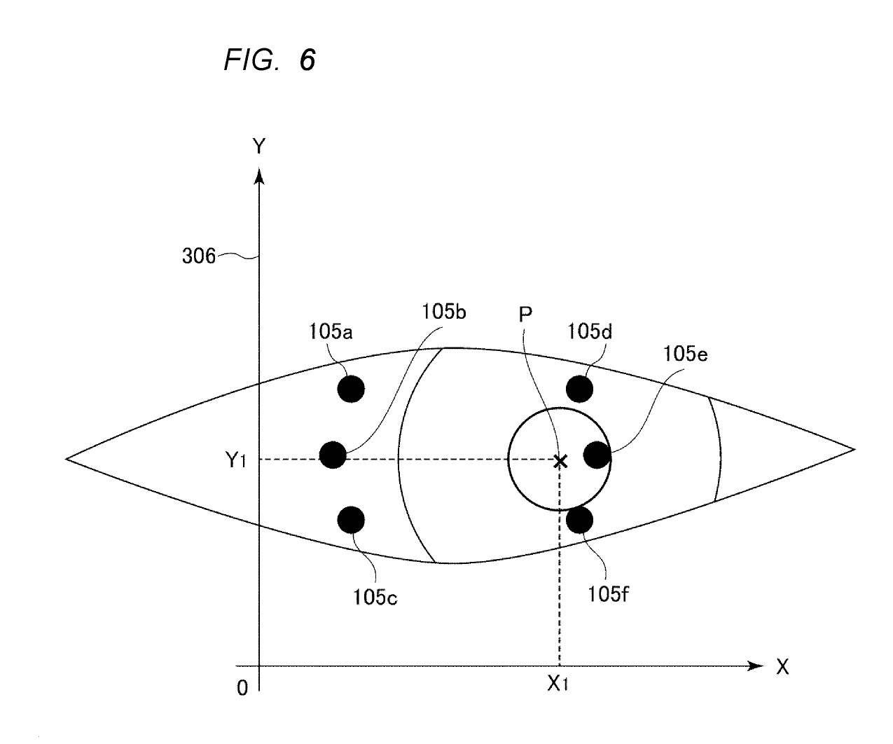

FIG. 6 is a schematic diagram illustrating the position coordinates of the cornea 302 of the user 300. The gaze detection unit 221 in the gaze detection device 200 analyzes the images captured by the camera 116 and detects bright spots 105 derived from the infrared light. When the user 300 gazes at each point by moving only his or her eyeballs, the positions of the bright spots 105 are considered to be stationary regardless of the point at which the user gazes. Thus, on the basis of the detected bright spots 105, the gaze detection unit 221 sets a two-dimensional coordinate system 306 in the image captured by the camera 116.

Further, the gaze detection unit 221 detects the center P of the cornea 302 of the user 300 by analyzing the image captured by the camera 116. This is realized by using known image processing such as the Hough transform or an edge extraction process. Accordingly, the gaze detection unit 221 can acquire the coordinates of the center P of the cornea 302 of the user 300 in the set two-dimensional coordinate system 306.

In FIG. 5, the coordinates of the points Q₁ to Q₉ in the two-dimensional coordinate system set for the display screen displayed by the image display element 108 are Q₁(x₁, y₁)^{T}, Q₂(x₂, y₂)^{T}, . . . , Q₉(x₉, x₉)^{T}, respectively. The coordinates are, for example, a number of a pixel located at a center of each point. Further, the center points P of the cornea 302 of the user 300 when the user 300 gazes at the points Q₁ to Q₉ are labeled P₁ to P₉. In this case, the coordinates of the points P₁ to P₉ in the two-dimensional coordinate system 306 are P₁(X₁, Y₁)^{T}, P₂(X₂, Y₂)^{T}, . . . , P₉(Z₉, Y₉)^{T}. T represents a transposition of a vector or a matrix.

A matrix M with a size of 2×2 is defined as Equation (1) below.

$$\begin{matrix}[ Math . 1 ] & \\ M = ( \begin{matrix}{m}_{11} & {m}_{12} \\ {m}_{21} & {m}_{22}\end{matrix} ) & ( 1 )\end{matrix}$$

In this case, if the matrix M satisfies Equation (2) below, the matrix M is a matrix for projecting the gaze direction of the user 300 onto an image plane that is displayed by the image display element 108.

P_{N}=MQ_{N}(N=1, . . . ,9) (2)

When Equation (2) is written specifically, Equation (3) below is obtained.

$$\begin{matrix}[ Math . 2 ] & \\ ( \begin{matrix}{x}_{1} & {x}_{2} & … & {x}_{9} \\ {y}_{1} & {y}_{2} & … & {y}_{9}\end{matrix} ) = ( \begin{matrix}{m}_{11} & {m}_{12} \\ {m}_{21} & {m}_{22}\end{matrix} ) ( \begin{matrix}{X}_{1} & {X}_{2} & … & {X}_{9} \\ {Y}_{1} & {Y}_{2} & … & {Y}_{9}\end{matrix} ) & ( 3 )\end{matrix}$$

By transforming Equation (3), Equation (4) below is obtained.

$$\begin{matrix}[ Math . 3 ] & \\ ( \begin{matrix}{x}_{1} \\ {x}_{2} \\ ⋮ \\ {x}_{9} \\ {y}_{1} \\ {y}_{2} \\ ⋮ \\ {y}_{9}\end{matrix} ) = ( \begin{matrix}{X}_{1} & {Y}_{1} & 0 & 0 \\ {X}_{2} & {Y}_{2} & 0 & 0 \\ ⋮ & ⋮ & ⋮ & ⋮ \\ {X}_{9} & {Y}_{9} & 0 & 0 \\ 0 & 0 & {X}_{1} & {Y}_{1} \\ 0 & 0 & {X}_{2} & {Y}_{2} \\ ⋮ & ⋮ & ⋮ & ⋮ \\ 0 & 0 & {X}_{9} & {Y}_{9}\end{matrix} ) ( \begin{matrix}{m}_{11} \\ {m}_{12} \\ {m}_{21} \\ {m}_{22}\end{matrix} ) & ( 4 ) \\ [ Math . 4 ] \\ y = ( \begin{matrix}{x}_{1} \\ {x}_{2} \\ ⋮ \\ {x}_{9} \\ {y}_{1} \\ {y}_{2} \\ ⋮ \\ {y}_{9}\end{matrix} ) , A = ( \begin{matrix}{X}_{1} & {Y}_{1} & 0 & 0 \\ {X}_{2} & {Y}_{2} & 0 & 0 \\ ⋮ & ⋮ & ⋮ & ⋮ \\ {X}_{9} & {Y}_{9} & 0 & 0 \\ 0 & 0 & {X}_{1} & {Y}_{1} \\ 0 & 0 & {X}_{2} & {Y}_{2} \\ ⋮ & ⋮ & ⋮ & ⋮ \\ 0 & 0 & {X}_{9} & {Y}_{9}\end{matrix} ) , x = ( \begin{matrix}{m}_{11} \\ {m}_{12} \\ {m}_{21} \\ {m}_{22}\end{matrix} ) , & \end{matrix}$$

Equation (5) below is obtained:

y=Ax (5)

In Equation (5), elements of the vector y are known since these are coordinates of the points Q₁ to Q₉ that are displayed on the image display element 108 by the gaze detection unit 221. Further, the elements of the matrix A can be acquired since the elements are coordinates of a vertex P of the cornea 302 of the user 300. Thus, the gaze detection unit 221 can acquire the vector y and the matrix A. A vector x that is a vector in which elements of a transformation matrix M are arranged is unknown. Since the vector y and matrix A are known, an issue of estimating matrix M becomes an issue of obtaining the unknown vector x.

Equation (5) becomes the main issue to decide if the number of equations (that is, the number of points Q presented to the user 300 by the gaze detection unit 221 at the time of calibration) is larger than the number of unknown numbers (that is, the number 4 of elements of the vector x). Since the number of equations is nine in the example illustrated in Equation (5), Equation (5) is the main issue to decide.

An error vector between the vector y and the vector Ax is defined as vector e. That is, e=y−Ax. In this case, a vector xₒₚₜ that is optimal in the sense of minimizing the sum of squares of the elements of the vector e can be obtained from Equation (6) below.

xₒₚₜ=(A^{T}A)⁻¹AT_{y} (6)

Here, “−1” indicates an inverse matrix.

The gaze detection unit 221 uses the elements of the obtained vector xₒₚₜ to constitute the matrix M of Equation (1). Accordingly, using the coordinates of the vertex P of the cornea 302 of the user 300 and the matrix M, the gaze detection unit 221 estimates a point at which the right eye of the user 300 is gazing on the video displayed by the image display element 108 within a two-dimensional range using Equation (2). Accordingly, the gaze detection unit 221 can calculate a right gaze vector that connects a gaze point of the right eye on the image display element 108 to a vertex of the cornea of the right eye of the user. Similarly, the gaze detection unit 221 can calculate a left gaze vector that connects a gaze point of the left eye on the image display element 108 to a vertex of the cornea of the left eye of the user using the image obtained by imaging the near-infrared light reflected by the left eye of the user.

The gaze detection unit 221 can detect an intersection between the right-eye gaze vector and the left-eye gaze vector as a focus of the user using the right-eye gaze vector and the left-eye gaze vector. When the two gaze vectors do not have intersection, for example, a midpoint of a line segment connecting points at which a distance between the two gaze vectors is shortest in the two viewing vectors may be set as the focus or a plane may be regarded as being present in a depth direction, intersections between the plane and the two gaze vectors may be specified, and a midpoint of a line segment connecting the intersections may be set as the focus as another scheme. It should be noted that the gaze position (a gaze coordinate position not including the depth information) on a plane of a displayed 3D image can be specified even with only one of the gaze vectors.

### <Operation>

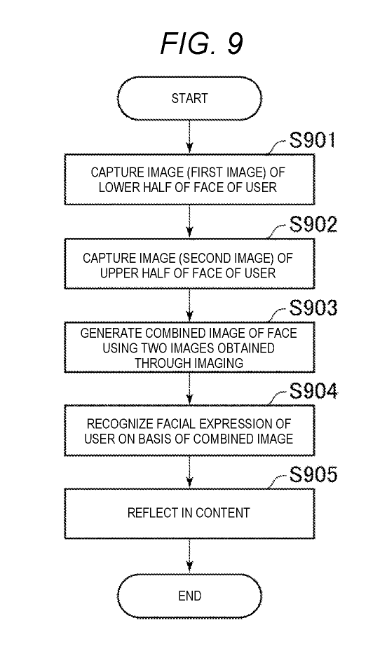

An operation related to the facial expression recognition in the facial expression recognition system 1 will be described. FIG. 9 is a flowchart illustrating an operation of the facial expression recognition system 1.

As illustrated in FIG. 9, the imaging unit 124 operates the camera 180 to capture the image of the lower half of the face of the user, that is, the first image (step S901). FIG. 7(a) illustrates an image example of the first image 701 obtained by the imaging. The imaging unit 124 transfers the first image obtained by imaging to the first communication unit 118. The first communication unit 118 transmits the received first image to the facial expression recognition device 200.

Then, the imaging unit 124 operates the camera 181 to capture an image of the upper half of the user (the periphery of the eyes), that is, a second image (step S902). An image example of the second image 702 obtained by the imaging is illustrated in FIG. 7(b). The imaging unit 124 transfers the second image obtained by imaging to the first communication unit 118. The first communication unit 118 transmits the received first image to the facial expression recognition device 200.

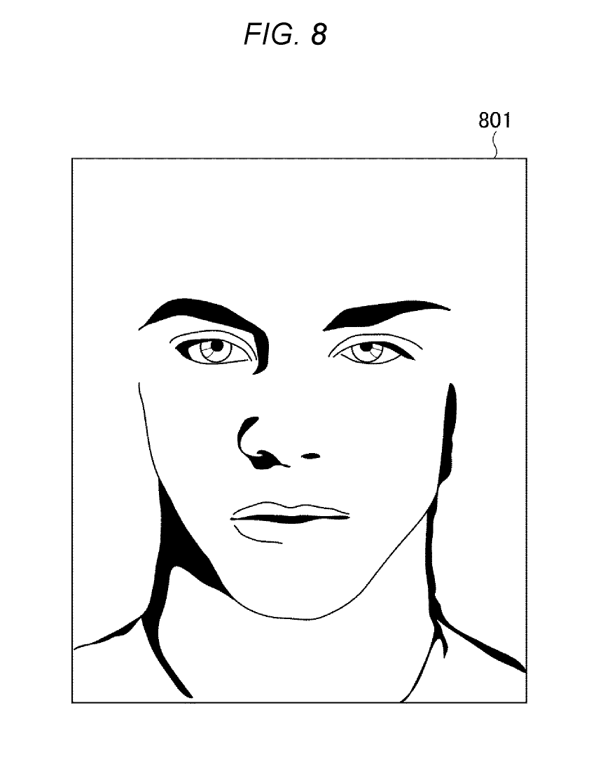

The second communication unit 220 of the facial expression recognition device 200 that has received the first image and the second image transfers the first image and the second image to the combination unit 222. The combination unit 222 combines the received first image 701 and the second image 702 according to a predetermined algorithm to generate a combined image showing the facial image of the user 300 (step S903). FIG. 8 illustrates an image example of the combined image 801 obtained by the combination. The combination unit 222 transfers the generated combined image 801 to the facial expression recognition unit 223.

The facial expression recognition unit 223 executes a facial expression recognition process on the received combined image 801 according to a predetermined algorithm to recognize and estimate the facial expression of the user 300 (step S904). The facial expression recognition unit 223 transfers the estimated facial expression information of the user 300 to the video output unit 224.

The video output unit 224 reflects the received facial expression information in the content (step S905).

The above is an operation related to the facial expression recognition of the facial expression recognition system 1.

### <Application Example of Facial Expression Recognition>

A method of reflecting the content of the facial expression recognition executed by the facial expression recognition system will be described herein.

It is possible to recognize a motion of the facial expression or emotion of the user through facial expression recognition of the facial expression recognition unit 223 described above. Therefore, the following application method can be considered.

### Utilization Example 1

A communication system in which a plurality of head mounted displays and at least one server system are connected through communication is assumed. It is assumed that a virtual reality space in which a plurality of characters operate is provided by the server system. It is assumed that users wearing the head mounted displays create respective avatars and come and go in a virtual world provided by the virtual reality space using the avatars.

In such a case, the facial expression of the user 300 is reflected in the corresponding avatar by estimating the facial expression of the user 300 using the head mounted display 100 described above. By doing so, a virtual reality space closer to reality can be provided, and communication in the virtual reality space can be made more active.

### Utilization Example 2

In utilization example 2, the same system as in utilization example 1 is assumed. It is assumed that, in the server system, a so-called non-player character which is not operated by the user is operated.

When the user is communicating with such a non-player character using his or her own avatar, the facial expression of the user 300 is estimated using the head mounted display 100 described above, the server system is notified of the facial expression, and a reaction based on the facial expression of the user is reflected in the non-player character. For example, when the user is recognized as laughing, the non-player character also laughs or becomes embarrassed, and when the user is recognized as being angry, the non-player character becomes angry or frightened.

### Utilization Example 3

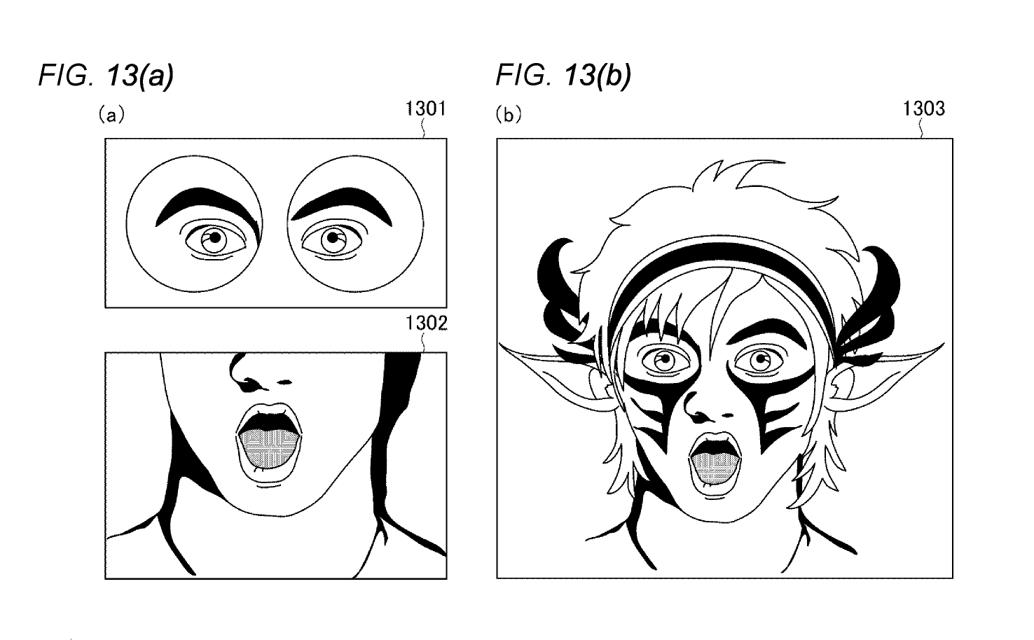

In utilization example 3, a case in which the video output unit 224 has a function of outputting an avatar image of the user is assumed. In this case, a shape of the mouth obtained on the basis of the first image from the camera 180 is reflected in the avatar image as it is, and a shape of the eyes obtained on the basis of the second image from the camera 181 is reflected in the avatar image as it is, such that a realistic representation of the avatar can be realized. An example thereof is illustrated in FIG. 13. FIG. 13(a) illustrates images 1301 and 1302 captured by the camera 180 and the camera 181. As illustrated in FIG. 13(a), a surprised appearance of the user can be recognized from the captured image. As illustrated in FIG. 13(b), the video output unit 224 outputs an avatar image 1303 in which the surprised appearance of the user recognized by the gaze detection system 1 is reflected. In this case, when depth cameras are used as the camera 180 and the camera 181, the above is particularly effective for generation of a three-dimensional shape of an avatar image.

### Utilization Example 4

In utilization example 4, the present invention can be applied to marketing for observing reactions of users to videos output by the video output unit 224. That is, the gaze detection system 1 specifies the object displayed forward in the gaze direction of the user detected by the gaze detection device 200 of the gaze detection system 1 and estimates an impression of the user with respect to the object on the basis of the facial expression of the user detected by the facial expression recognition unit 223. For example, when the facial expression of the user is recognized as a gentle expression, the gaze detection system 1 can estimate that the user has a favorable emotion with respect to the display object, and when the facial expression of the user is recognized as showing aversion, the gaze detection system 1 can estimate that the user has an aversion to the display object. Thereby, for example, when the display object is some kind of product or the like, information on whether or not the user likes the product can be collected, and when such information is collected from various users, marketing of more popular products can be performed.

### Utilization Example 5

In utilization example 5, content of the video can be changed on the basis of the facial expression shown by the user with respect to the video output by the video output unit 224. That is, as the video output from the video output unit 224, a branch point is provided in the video, different videos derived from the branch point are prepared, and an image with different endings such as a multi-ending story is prepared. For the facial expression shown for the video by the user, a video to be output to the user is determined according to whether or not the user shows a favorable facial expression, and a video with a branched story may be output. Thereby, it is possible to provide a video with a story more desirable for the user.

### Utilization Example 6

In utilization example 6, when the video output unit 224 is outputting a game image, it is possible to dynamically change a difficulty level of the game on the basis of the facial expression of the user. Specifically, when it is recognized that the user playing the game using the head mounted display 100 has a severe expression, the game is difficult for the user, and therefore the video output unit 224 decreases the difficulty level of the game and outputs a game image with the decreased difficulty level. On the other hand, when it is recognized that the user has a calm facial expression, the game is easy for the user, and therefore the video output unit 224 increases the difficulty level of the game and outputs a game image with the increased difficulty level. Here, although the video output unit 224 has been described as further serving as a game engine, the game engine may be provided separately from the video output unit 224, and the video output unit 224 may output the image transferred from the game engine to the head mounted display 100.

### Utilization Example 7

In utilization example 7, the user image showing the head mounted display 100 can be interactively changed on the basis of the image captured using the cameras 180 and 181 when a real-time live comment using the head mounted display 100 is performed.

### <Conclusion>

As described above, according to the head mounted display of the present invention, it is possible to acquire the facial image of the user by imaging different parts with a plurality of cameras and combining the images. Accordingly, it is possible to perform facial expression recognition and reflect the facial expression in various pieces of content.

### <Supplements>

It is apparent that the facial expression recognition system according to the present invention is not limited to the above embodiment and may be realized using another scheme for realizing the spirit of the invention. Hereinafter, an example included as the spirit of the present invention will be described.

(1) Although the image reflected by the hot mirror 112 is captured as a scheme of imaging the eyes of the user 300 in order to detect the gaze of the user 300 in the above embodiment, the eyes of the user 300 may be directly imaged without using the hot mirror 112.

(2) The above-described embodiment is realized by capturing the first and second images with the cameras 180 and 181, respectively, and obtaining a combined image of the face in order to perform the facial expression of the user 300. However, a scheme of performing the facial expression recognition of the user is not limited thereto.

By detecting motions of facial muscles in the face of the user, it is possible to estimate a motion of the periphery of the eyes of the user and apply the motion to the facial expression recognition. Specifically, a contact sensor, such as a strain sensor, that can specify the facial expression of the user at a position that comes into contact with the periphery of the eyes of the user when the head mounted display 100 is mounted on the user may be provided in the head mounted display 100. The facial expression recognition unit 223 may recognize the facial expression of the periphery of the eyes on the basis of data indicating the motion of the periphery of the eyes of the user detected by the contact sensor.

(3) In the above embodiment, only the facial expression of the user 300 is recognized. However, a state of the user 300 other than the facial expression can also be recognized and reflected in various pieces of content according to an imaging range based on an angle of view of the camera 180.

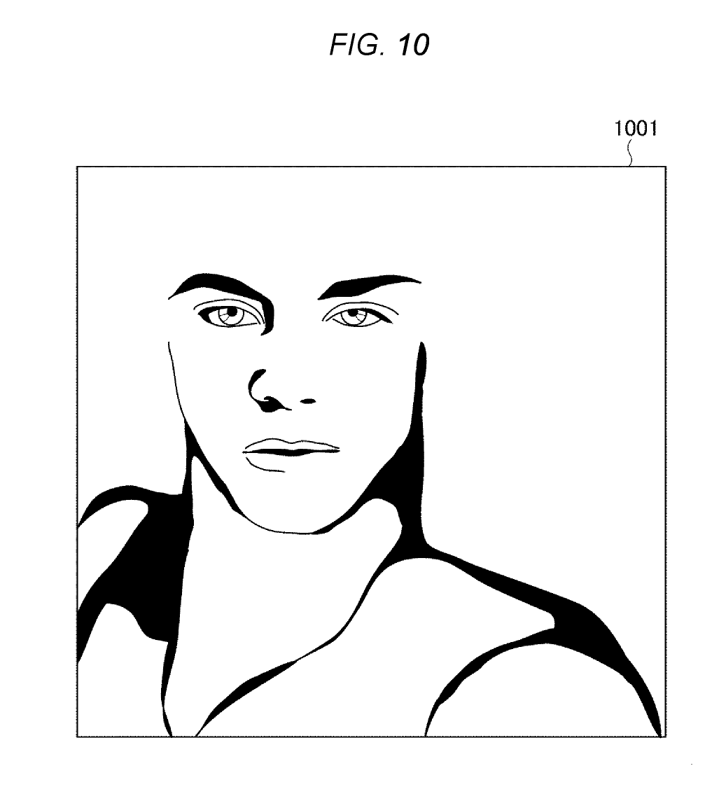

For example, the camera 180 may be disposed to capture an image up to a shoulder of the user 300. Then, in the combined image 1001 obtained by combining the first image and the second image in the combination unit 222, an image in which a state of the shoulder of the user 300 can also be recognized is obtained, as illustrated in FIG. 10. In the case of the combined image 1001 of FIG. 10, since the left shoulder of the user 300 can be analyzed as being located at a front side of the image, an image in which the left shoulder of the avatar is tilted forward may be generated, for example, when the avatar image of the user 300 is generated.

By analyzing the image 1001 using the image recognition unit 223, it is possible to estimate a posture of the body of the user. For example, a posture of the character operated by the user may be controlled on the basis of the estimated posture. It should be noted that a posture estimation unit that estimates the posture of the user from the combined image may be separately provided in the facial expression recognition device 200.

It should be noted that for this analysis, a technology for estimating a posture of a human body using an image analysis technology of the related art, such as a markerless motion capturing technology or pattern matching using a sample image showing various postures of a user, may be used.

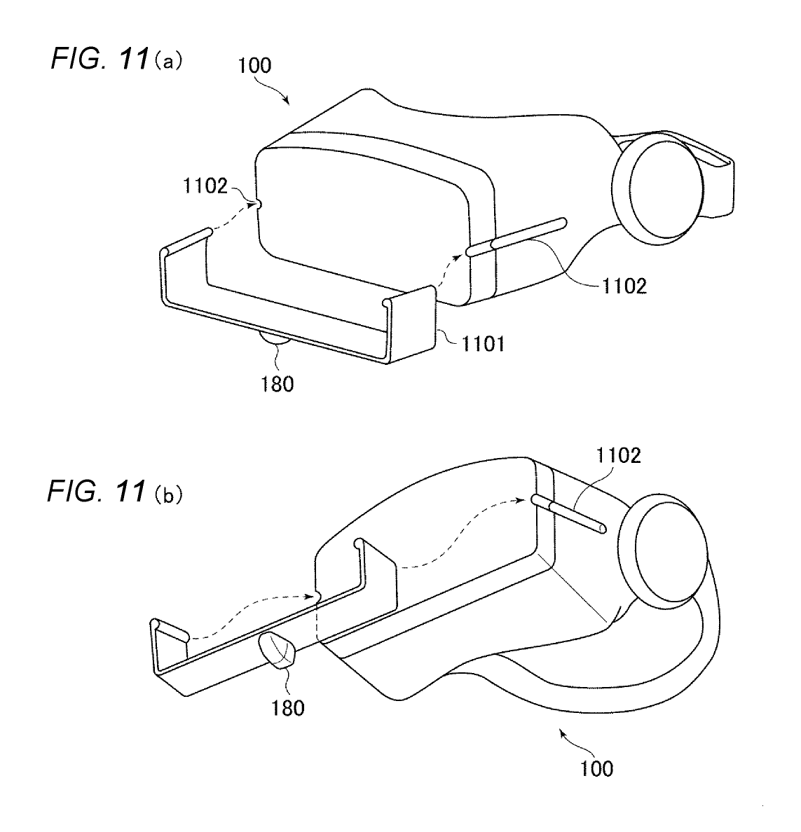

(4) The camera 180 is provided in the head mounted display 100 in the above embodiment, but the camera 180 may be configured to be detachable. An example thereof is illustrated in FIG. 11.

FIG. 11(a) is a perspective view of an example in which the camera 180 is attached to the head mounted display 100 when viewed from above the head mounted display 100, and FIG. 11(b) is a perspective view when viewed from below the head mounted display 100.

As illustrated in FIGS. 11(a) and 11(b), the camera 180 is attached to a U-shaped member 1101. Further, a slide groove 1102 is provided in the head mounted display 100. Projections are provided on both end portions of the member 1101 to fit into the slide groove 1102. The projections are slid and inserted into the slide groove 1102 to mount the camera 180 on the head mounted display. In this case, the member 1101 may be configured to be able to be fixed at several places of the slide groove 1102.

In this case, the camera 180 may have a wireless communication function, and the first communication unit 118 of the head mounted display 100 may be configured to receive the first image captured by the camera 180.

It should be noted that the attachment example illustrated in FIG. 11 is merely an example, and it is apparent that a detachable configuration may be realized using other methods. For example, a mortise hole may be provided in the head mounted display, and a tenon to be fitted into the mortise hole may be provided on the camera 180 side for a detachable configuration, or the detachable configuration may be realized by screwing.

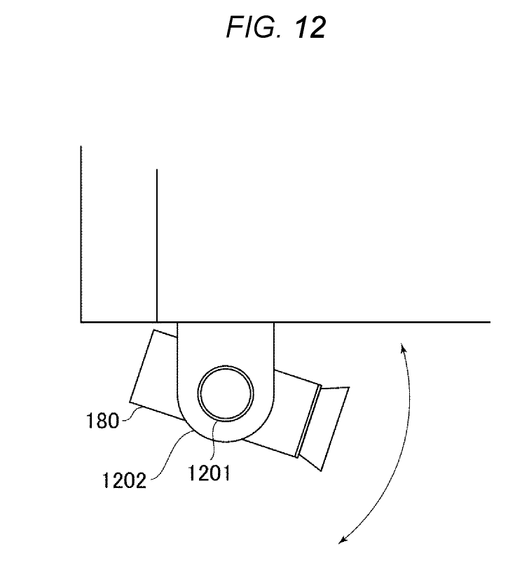

(5) The camera 180 in the above embodiment may be rotatably provided on the head mounted display 100. That is, the camera 180 may be provided on the head mounted display 100 in the form illustrated in FIG. 12.

FIG. 12 is an enlarged view of a side of the head mounted display 100, which is a place to which the camera 180 is attached. As illustrated in FIG. 12, the camera 180 is attached to the head mounted display 100 to be rotated by a rotation shaft 1201 supported by a holding unit 1202. With such a configuration, it is possible to capture an image at an appropriate angle when the first image is captured, according to a physique of the user or the like.

Further, the rotation shaft 1201 may be configured to be fixed at a predetermined rotation angle. By doing so, even when the user 300 moves, it is possible to prevent an imaging angle of the camera 180 from being changed. Furthermore, a rotation motor may be included on the rotation shaft 1201, and the imaging unit 124 may control the rotation motor at the time of imaging so that a desired first image can be captured. Further, a plurality of first images may be captured at various rotation angles, and a plurality of captured first and second images may be combined by the combination unit 222. By doing so, it is possible to acquire a larger image showing the state of the user 300.

(6) A type of head mounted display that covers the periphery of the eyes of a user has been illustrated in the above embodiment, but the present invention is not limited thereto. For example, the head mounted display may be a full-face type head mounted display. In this case, a plurality of cameras for imaging the face of the user may be included, and facial expression recognition may be performed with a facial image obtained by combining the images captured by the plurality of cameras.

(7) In the above-described embodiment, the combination unit 222 is included to combine the images captured by the camera 180 and the camera 181 and realize the recognition of the facial expression of the user. However, the gaze detection system 1 may not include the combination unit 222 and may specify the shape of the mouth of the user on the basis of the image captured by the camera 180, specify the shape of the eyes of the user on the basis of the image captured by the camera 181, and realize the facial expression recognition on the basis of the shapes of the eyes and the mouth specified independently. Further, in this case, the facial expression recognition may not be performed, and the shapes of the eyes or the mouth detected in parts may be reflected in each part when the avatar image generation unit included in the gaze detection system 1 generates the avatar image of the user. That is, for example, the shape of the mouth of the user may be specified on the basis of the image captured by the camera 180, and only the specified mouth shape may be reflected in the avatar image.

Further, as a scheme for reflecting the facial expression in the avatar image for the facial expression recognition, the following scheme may be adopted. The storage unit 225 may realize imaging for gaze detection and facial expression recognition using the following scheme for classifying facial expressions of users in advance. For example, classifications such as anger, disgust, fear, happiness, sadness, and surprise are prepared, and a correspondence table in which patterns of facial images showing facial expressions according to the respective classifications (shape patterns of arrangements of respective parts of the face or parts corresponding to facial expressions according to respective emotions) are associated is stored. The facial expression recognition system may include an avatar image generation unit that specifies a pattern of the facial image corresponding to the specified classification on the basis of the classification corresponding to the facial expression recognized by the facial expression recognition unit 223 and creates an avatar image in which the specified pattern is reflected.

In this case, in the correspondence table, each classification may be associated with a pattern of a facial image according to a degree of each facial expression (emotion). For example, as an example of an anger classification, five degrees from “slightly angry” to “very angry” are provided, and in the case of very angry, a pattern of a facial image such as a higher degree of raising of eyebrows, a higher degree of descent of the corners of the mouth, and a higher degree of swelling of cheeks than in the case of slightly angry may be associated. Further, the facial expression recognition unit 223 determines a step of each classification of the recognized facial expression. This step is determined from, for example, a degree of a vertical position of ends of the eyebrows, a degree of a vertical position of corners of the eyes, and a degree of opening of the eyes based on the image captured by the camera 181, and a degree of a vertical position of corners of the mouth and a degree of opening of the mouth based on the image captured by the camera 180. Thus, the facial expression recognition system may realize facial expression recognition and reflect the facial expression in the avatar image.

(8) Although the camera 116 and the camera 181 are used as separate cameras in the above embodiment, a shared camera may be used for these cameras. For example, it is assumed that only the camera 116 is used without using the camera 181, a visible light camera is adopted as the camera 116, and using a stereo camera, the eyes are recognized three-dimensionally, the shapes of the eyeballs are recognized three-dimensionally, and a gaze direction is detected. For facial expression recognition, an original image is used.

Further, alternatively, a camera having both functions of imaging in a visible light mode and imaging in an infrared mode is used as the camera 116, and the head mounted display 100 performs switching to perform the imaging in the infrared mode when performing gaze detection and the imaging in the visible light mode when performing the facial expression recognition. This switching can be realized, for example, by filter switching between an infrared pass filter and a visible light pass filter.

It should be noted that, although the case in which the camera 116 is used without using the camera 181 has been described by way of example herein, it is obvious that the camera 181 may be used without using the camera 116. In this case, it is not necessary for the hot mirror 112 to be included.

(9) Although the processor of the facial expression recognition device 200 executes the gaze detection program and the like to specify the point gazed at by the user as a facial expression recognition scheme in the above embodiment, this may be realized by a logical circuit (hardware) formed of an integrated circuit (an integrated circuit (IC) chip or large scale integration (LSI)) or the like or a dedicated circuit in the facial expression recognition device 200. Further, the circuit may be realized by one or a plurality of integrated circuits, or the functions of the plurality of functional units described above may be realized by one integrated circuit. The LSI may be called VLSI, super LSI, ultra LSI, or the like according to an integration difference.

Further, the gaze detection program may be recorded on a processor-readable recording medium, and the recording medium may be a “non-transitory tangible medium” such as a tape, a disk, a card, a semiconductor memory, or a programmable logic circuit. Further, the search program may be supplied to the processor through an arbitrary transmission medium (such as a communication network or broadcast waves) capable of transmitting the search program. The present invention can also be realized in the form of a data signal embodied in carrier waves, in which the gaze detection program is implemented by electronic transmission.

It should be noted that the gaze detection program may be installed using, for example, a script language such as ActionScript, JavaScript (registered trademark), Python, or Ruby, a compiler language such as a C language, C++, C#, Objective-C, or Java (registered trademark).

(10) The respective configurations and the content described in the respective supplements may be used in appropriate combinations.

### REFERENCE SIGNS LIST

1 facial expression recognition system
100 head mounted display
103a infrared light source (second infrared light irradiation unit)
103b infrared light source (first infrared light irradiation unit)
105 bright spot
108 image display element
112 hot mirror
114, 114a, 114b convex lens
116 camera
118 first communication unit
121 display unit
122 infrared light irradiation unit
123 image processing unit
124 imaging unit
130 image display system
150 housing
152a, 152b lens holder
160 fitting harness
170 headphone
180, 181 camera
200 facial expression recognition device
220 second communication unit
221 gaze detection unit
222 combination unit
223 facial expression recognition unit
224 video output unit
225 storage unit

### INDUSTRIAL APPLICABILITY

The present invention can be applied to a head mounted display.

1. A facial expression recognition system comprising:
a head mounted display including
a first camera that images eyes of a user,
a second camera that images a mouth of the user,
an output unit that outputs a first image captured by the first camera and a second image captured by the second camera, and
a housing in which the first camera, the second camera, and the output unit are mounted and that covers the periphery of the eyes of the user when the head mounted display is mounted on a head of the user; and
a facial expression recognition device including
a reception unit that receives the first image and the second image output by the output unit, and
an expression recognition unit that recognizes a facial expression of the user on the basis of the first image and the second image.

2. The facial expression recognition system according to claim 1,
wherein the head mounted display further includes:
a light source that irradiates the eyes of the user with invisible light; and
a third camera that images the invisible light reflected by the eyes of the user,
the output unit outputs a third image captured by the third camera, and
the facial expression recognition device further includes a gaze detection unit that detects a gaze direction of the user on the basis of the third image received by the reception unit.

3. The facial expression recognition system according to claim 1,
wherein the facial expression recognition device further includes a combination unit that combines the first image and the second image received by the reception unit to create a combined image, and
the facial expression recognition unit recognizes the facial expression of the user on the basis of the combined image.

4. The facial expression recognition system according to claim 1, wherein the second camera is detachably attached to the head mounted display.

5. The facial expression recognition system according to claim 1, wherein the second camera is attached to a lower portion of the housing when the user wears the head mounted display, and is attached to the head mounted display so that a range from a nose to a shoulder of the user becomes an imageable angle of view.

6. The facial expression recognition system according to claim 1, wherein the facial expression recognition system further includes a posture estimation unit that estimates a posture of the user on the basis of the second image received by the reception unit.

7. The facial expression recognition system according to claim 1, wherein the head mounted display is configured not to cover the mouth of the user.

8. The facial expression recognition system according to claim 1,
wherein the first camera and the second camera are cameras that acquire depth information indicating a distance to an imaging target, and
the facial expression recognition system further comprises an avatar image generation unit that specifies a three-dimensional shape of the eyes and the mouth of the user on the basis of the image of the eyes of the user captured by the first camera and the image of the mouth of the user captured by the second camera, and generates an avatar image in which the specified three-dimensional shape is reflected in the shape of the eyes and the mouth of the avatar of the user on the basis of the specified three-dimensional shape.

9. The facial expression recognition system according to claim 1,
wherein the facial expression recognition device further includes a storage unit that stores a correspondence table in which patterns of facial images are stored according to a plurality of facial expression classifications,
the facial expression recognition unit recognizes the classification to which the facial expression of the user corresponds on the basis of the second image, and
the facial expression recognition system further comprises an avatar image generation unit that specifies a pattern of a facial image corresponding to a facial expression recognized by the facial expression recognition unit by referring to the correspondence table, and generates an avatar image of the user on the basis of the specified pattern of the facial image.

10. The facial expression recognition system according to claim 2, wherein the first camera and the third camera are the same camera.

11. A facial expression recognition method using a facial expression recognition system including a head mounted display including a housing that covers the periphery of eyes of a user when mounted on a head of the user, and a facial expression recognition device, the facial expression recognition method comprising:
a first imaging step of capturing, by the head mounted display, a first image showing the eyes of the user;
a second imaging step of capturing, by the head mounted display, a second image showing a mouth of the user;
a combination step of combining, by the facial expression recognition device, the first image and the second image to create a combined image; and
a recognition step of recognizing a facial expression of the user on the basis of the combined image.

12. A facial expression recognition program causing a computer of a facial expression recognition device to realize:
a first acquiring function of acquiring a first image showing eyes of the user captured by a head mounted display including a housing that covers the periphery of eyes of a user when mounted on a head of the user;
a second acquiring function of acquiring a second image showing a mouth of the user captured by the head mounted display;
a combination function of combining the first image and the second image to create a combined image; and
a recognition function of recognizing a facial expression of the user on the basis of the combined image.
